(19) United States
(12) Patent Application Publication
(10) Pub. No.: US 2024/0163990 A1
(43) Pub. Date: May 16, 2024

(54) SEMICONDUCTOR DEVICE AND SYNCHRONIZATION SYSTEM

(71) Applicant: ROHM CO., LTD., Kyoto (JP)

(72) Inventor: Kei Nagao, Kyoto (JP)

(21) Appl. No.: 18/388,740

(22) Filed: Nov. 10, 2023

(30) Foreign Application Priority Data
Nov. 14, 2022 (JP) 2022-181640

(51) Int. Cl. H05B 45/325; H05B 45/345; H05B 47/16

(52) U.S. Cl. CPC H05B 45/325; H05B 45/345; H05B 47/16; H05B 45/50

(57) ABSTRACT

The present disclosure provides a semiconductor device comprising a PWM synchronization unit and a PWM control unit. The PWM synchronization unit includes a periodic counter and a one-step counter. The periodic counter is configured to count PWM periods between externally controlled synchronization timings. The one-step counter is configured that a count value of each step is set as X with a remainder as MOD when the count value of the periodic counter is divided by a predetermined resolution Y. For a step number of MOD steps, (X+1) is counted per step, and for a step number of (Y−MOD) steps, X is counted per step. The PWM control unit is configured to perform PWM control based on counts of the one-step counter.

### TECHNICAL FIELD

The present disclosure relates to a semiconductor device and a synchronization system.

### BACKGROUND

A semiconductor device having a pulse width modulation (PWM) control function is conventionally available. For example, a semiconductor device (LED drive device) as below is known. The semiconductor device has a PWM modulation function for a light emitting diode (LED) (for example, patent publication 1).

### PRIOR ART DOCUMENT

### Patent Publication

[Patent publication 1] International Publication No. 2020/54096

### BRIEF DESCRIPTION OF THE DRAWINGS

FIG. 1 is a diagram of a configuration of a light emitting system according to an exemplary embodiment of the present disclosure.

FIG. 2 is a diagram of a configuration of a PWM synchronization unit according to the first embodiment.

FIG. 3 is a timing diagram of an example using PWM control of the PWM synchronization unit of the first embodiment.

FIG. 4 is a diagram of a configuration of a PWM synchronization unit according to a second embodiment.

FIG. 5 is a diagram of an example of a step value output by a one-step counter according to the second embodiment.

FIG. 6 is a timing diagram of an example using PWM control of the PWM synchronization unit of the second embodiment.

### DETAILED DESCRIPTION OF THE EMBODIMENTS

Details of the exemplary embodiments of the present disclosure are given with the accompanying drawings below.

### 1. LED DRIVE DEVICE

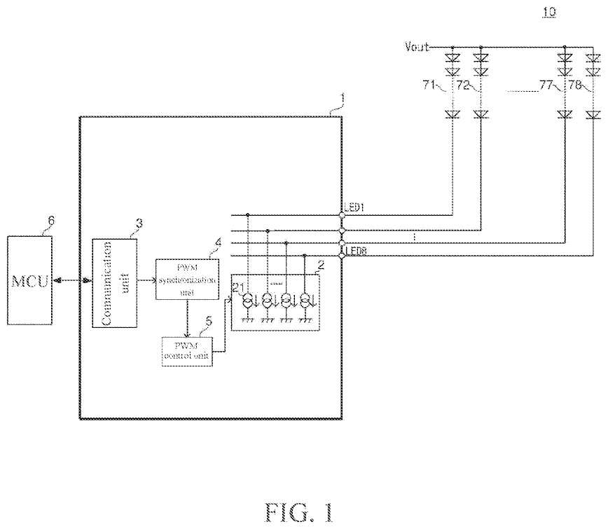

FIG. 1 shows a diagram of a configuration of a light emitting system 10 according to an exemplary embodiment of the present disclosure. The light emitting system 10 shown in FIG. 1 includes an LED drive device 1, an MCU 6, and LEDs 71 to 78.

The LED drive device 1 is configured to drive LEDs of multiple channels, and drives the LEDs 71 to 78 of 8 channels, for example. An anode of each of the LEDs 71 to 78 is connected to an application end of an output voltage Vout output by a direct current (DC)/DC converter. The DC/DC converter is, for example, a boost circuit that boosts a power supply voltage.

The LED drive device 1 is a semiconductor device that integrates at least internal structures shown in FIG. 1. Moreover, the LED drive device is an example of a semiconductor device of the present disclosure, and the semiconductor device can also be a device having a function different from driving LEDs.

The LED drive device 1 includes LED1 to LED8 terminals, which serve as external terminals for asserting electrical connections to the exterior. Cathodes of the LEDs 71 to 78 are respectively connected to the individual LED1 to LED8 terminals.

The LED drive device 1 includes a current driver 2, a communication unit 3, a PWM synchronization unit 4 and a PWM control unit 5 as internal structures. Moreover, in addition to having the configuration shown in FIG. 1, the LED drive device 1 can further include a configuration associated with a DC/DC converter function, and various protection circuits (for example, under voltage lock-out (UVLO), and LED ground short-circuit detection).

The current driver 2 has a function of enabling a constant current to flow in each of the LEDs 71 to 78. More specifically, the current driver 2 includes a constant current circuit 21 connected to a channel between each of the LED1 to LED8 terminals and ground. The constant current circuits 21 to 28 of the channels generate constant currents respectively flowing in LEDs 71 to 78.

The communication unit 3 is configured to communicate between the semiconductor device 1 and the external MCU 6. The communication performed by the communication unit 3 is implemented by means of a universal asynchronous receiver/transmitter (UART). The UART is used to exchange protocols of serial data between two elements. In the UART, bi-directional communication is performed by using two lines between a receiver and a transmitter.

The PWM synchronization unit 4 is a function unit that performs external synchronization of PWM control based on a synchronization timing sent from the MCU 6 via the communication unit 3. The PWM control unit 5 performs PWM control on the current driver 2 based on an output of a one-step counter (which performs one-step counting of a resolution) included in the PWM synchronization unit 4 to perform PWM modulation of the LEDs 71 to 78. Details of the PWM synchronization unit 4 and the PWM control unit 5 are to be described below.

### 2. PWM SYNCHRONIZATION UNIT

### 2-1. First Embodiment

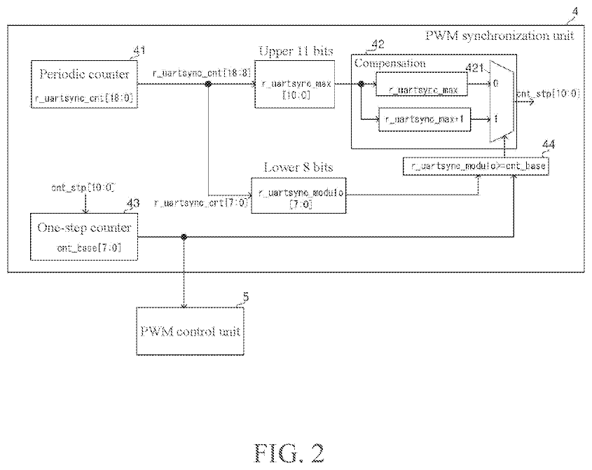

FIG. 2 shows a diagram of a configuration of the PWM synchronization unit 4 according to the first embodiment. The PWM synchronization unit 4 shown in FIG. 2 includes a periodic counter 41, a synchronization compensation unit 42, a one-step counter 43 and a comparison unit 44.

The periodic counter 41 counts a clock of a predetermined frequency, and outputs a count value of a PWM period specified by a synchronization timing, which is sent from the MCU 6 and set by the communication unit 3. In FIG. 2, for example, the count (r_uartsync_cnt[18:0]) is set as a 19-bit data.

In the PWM synchronization unit 4, the count value of each step is set as X with a remainder as MOD when the count value of the periodic counter 41 is divided by a predetermined resolution. When the count value (r_uartsync_cnt[18:0]) of the periodic counter 41 is 011_0011_0110_1000_0111=210567 and the resolution is 8-bit (=256 steps), the count value X is 822 with the remainder MOD of 135.

As shown in FIG. 2, lower 8 bits (r_uartsync_cnt[7:0]) of the count value (r_uartsync_cnt[18:0]) of the periodic counter 41 are equivalent to the remainder MOD (r_uartsync_modulo[7:0]), and higher 11 bits (r_uartsync_cnt[18:8]) of the count value (r_uartsync_cnt[18:0]) of the periodic counter 41 are equivalent to the count value X (r_uartsync_max[10:0]). That is to say, r_uartsync_max[10:0]=011_0011_0110=822, r_uartsync_modulo [7:0]=1000_0111=135.

Herein, the count value of the periodic counter 41 is represented by (X+1)×MOD+X×(resolution−MOD). That is to say, for a step number of MOD steps in the resolution, (X+1) is counted per step, and for a step number of (resolution-MOD) steps, X is counted per step, so it is equivalent to counting one PWM period.

Thus, in the configuration shown in FIG. 2, a selection unit 421 is provided in the synchronization compensation unit 42, and (X+1)(r_uartsync_max+1) or X(r_uartsync_max) is selected and output by the selection unit 421. The count value (cnt_stp[10:0]) of each step output from the selection unit 421 is input to the one-step counter 43.

The one-step counter 43 increases the step value (cnt_base[7:0]) from 0 to (resolution−1) by 1 based on the one-step count (the count of the clock) output by the selection unit 421 each time one step is counted, and outputs the step value. When the resolution is 8-bit, the one-step counter 43 increases the step value from 0 to 255 by 1, and outputs the step value.

The comparison unit 44 compares (MOD−1)(r_uartsync_modulo[7:0]−1) with the step value (cnt_base[7:0]) output from the one-step counter 43. When the step value is (MOD−1) or less, the selection unit 421 selects and outputs (X+1) (r_uartsync_max+1); when the step value exceeds (MOD−1), the selection unit 421 selects and outputs X (r_uartsync_max). For example, as described above, when MOD=135, (X+1) is output if the step value is 0 to 134, and X is output if the step value is 135 to 255.

The PWM control unit 5 shown in FIG. 2 performs PWM control based on a duty cycle set value and the step value output from the one-step counter 43. More specifically, a step represented by “resolution×duty[%]” is set as an on-time, and a step represented by “resolution×(100−duty)[%] is set as an off-time. When the resolution is 8-bit and the duty cycle is 50%, for example, an on-time is set if the step value output from the single step counter 43 is between 0 and 127, and an off-time is set if the step value output from the single step counter 43 is between 128 and 255. The PWM control unit 5 sets the constant current circuit 21 to on during the on-time, and sets the constant current circuit 21 to off during the off-time. Thus, the on-time becomes a light-on-time of the LEDs and the off-time become a light-off-time of the LEDs.

Moreover, the PWM control unit 5 can control the constant current circuit 21 for each channel. Accordingly, the duty cycle can be different for each channel, and phase shift described below can also be performed.

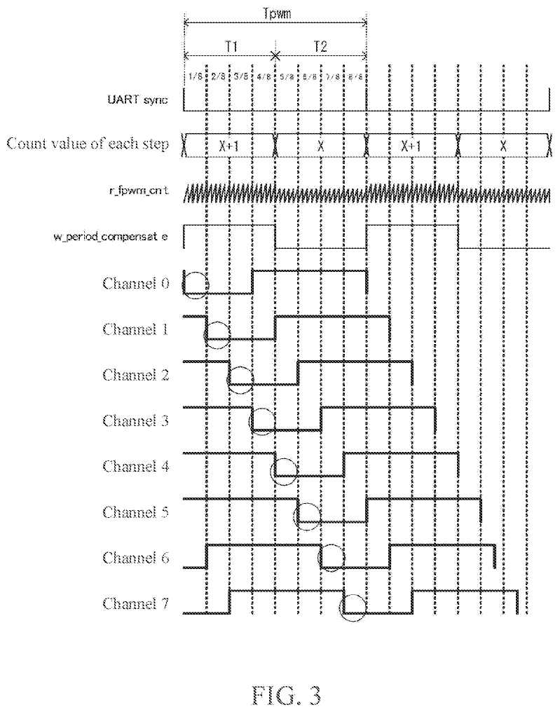

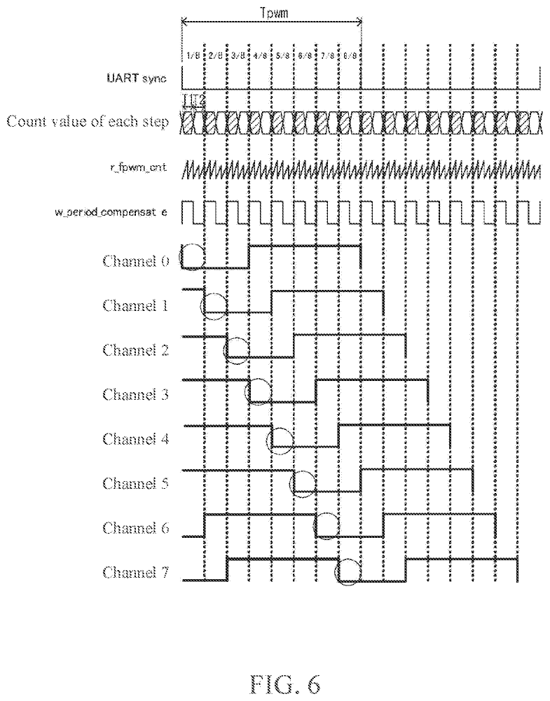

FIG. 3 shows a timing diagram of an example using PWM control of the PWM synchronization unit 4 of this embodiment. In FIG. 3 and FIG. 6 in the following description, a synchronization timing (UART sync) sent from the MCU 6, a selection result of the count value X or (X+1) for each step, a count (r_fpwm_cnt) of one step of the one-step counter 43, the presence of compensation of the synchronization compensation unit 42, and modulation control of each channel (channel 0 to channel 7) of the LEDs are sequentially represented from the top. Moreover, in each channel in FIG. 3, a low level represents an off-time (light-off-time) and a high level represents an on-time (light-on-time).

In the example in FIG. 3, a count value obtained by counting a PWM period Tpwm between synchronization timings using the periodic counter 41 is 210567, and the resolution is 8-bit (=256 steps), and thus the count value X is 822, and the remainder MOD is 135. Accordingly, during a period T1 (with compensation) in which the step value output from the one-step counter 43 is 0 to 134, the one-step counter 43 counts (X+1) for each step; in a period T2 (without compensation) in which the step value output from the one-step counter 43 is 135 to 255, the one-step counter 43 counts X for each step.

In the example in FIG. 3, since the duty cycle of PWM modulation in each channel of the LEDs is ⅝, the step of 256×(⅝) becomes the on-time, and the step 256×(1−⅝)) becomes the off-time. As such, one period of PWM modulation can be synchronized with the synchronization timing sent from the MCU 6, thereby implementing external synchronization of PWM control.

Moreover, in the example in FIG. 3, phase shift is performed; that is, phase is shifted sequentially for each channel according to a period (⅛˜ 8/8) of dividing the PWM period Tpwm by the number of channels.

Moreover, regarding control in this embodiment, compensation is performed during a first half of the PWM period Tpwm, and no compensation is performed during the second half; alternatively, no compensation is performed during the first half and compensation is performed during the second half. In this case, the one-step counter 43 decreases the step value from (resolution−1) by 1 to 0 and outputs the step value.

### 2-2. Second Embodiment

In the example in FIG. 3, phase shift is performed in the PWM control. However, in an equivalent period of the PWM control indicated by the circles in FIG. 3, for example, a channel for which compensation is performed and a channel for which compensation is not performed may exist at the same time. To improve the above issue, a second embodiment is described below.

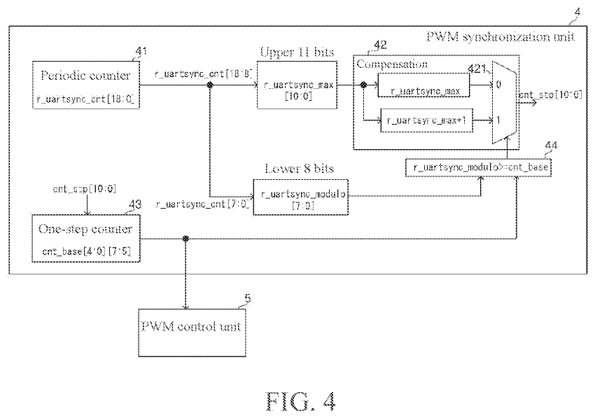

FIG. 4 shows a diagram of a configuration of the PWM synchronization unit 4 according to the second embodiment. A difference from the first embodiment is that, in this embodiment, when a bit data of the step value is arranged to increase from 0 to (resolution−1) by 1, the one-step counter 43 uses the bit data in which upper bits and lower bits of the bit data are swapped and sequentially outputs said bit data after swapping as a step value.

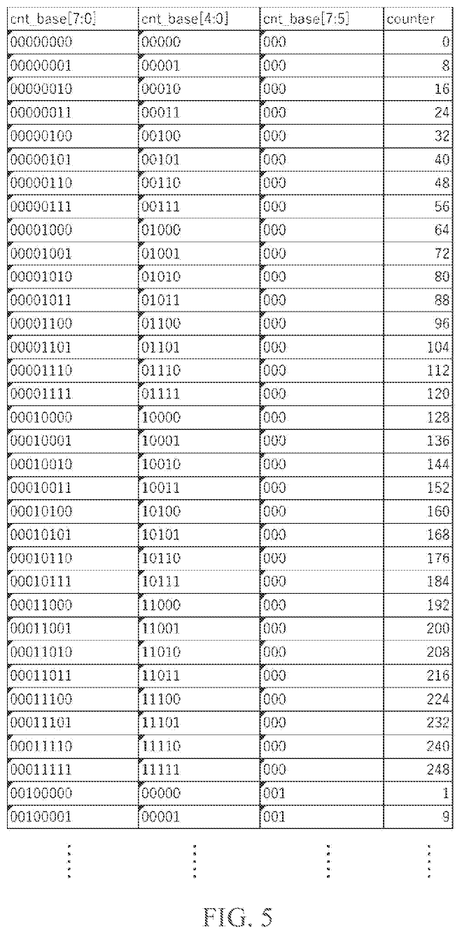

For example, when the resolution is 8-bit, as shown in FIG. 5, when a bit data (cnt_base[7:0]) of the step value is arranged to increase from 0 to (256−1)=255 by 1, the bit data in which upper 3 bits (cnt_base[7:5]) and lower 5 bits (cnt_base[4:0]) are swapped is sequentially output. As shown in FIG. 5, in the bit data after swapping, the step value increases from 0 to 248 when the lower 3 bit data become 000 after swapping, and then, the step value decreases from 248 to 1 and again increases when the lower 3 bit data becomes 001 after swapping. Then, the step value repeatedly increases until the lower 3 bit data after swapping becomes 111.

Accordingly, for example, in the comparison unit 44, (MOD−1) is compared with the step value (cnt_base[4:0][7:5]) output from the one-step counter 43. When the lower bit data (cnt_base[7:5]) of the step value is the same value, a period in which the step value is less than (MOD−1) and a period in which the step value exceeds (MOD−1) occur. For example, in the example in FIG. 5, MOD=135, when the lower 3 bit data of the step value is 000, a period (0 to 128) in which the step value is less than (MOD−1) and a period in which the step value exceeds (MOD−1) occur, and such repeatedly occurs subsequently. Thus, when the lower 3 bit data is the same value, a period in which (X+1) is selected as the count value of each step and a period in which X is selected as the count value of each step occur.

FIG. 6 shows a timing diagram of an example using PWM control of the PWM synchronization unit 4 of this embodiment. FIG. 6 corresponds to FIG. 5. As described above, the number of upper bits when upper bits and lower bits of bit data of the step value are swapped corresponds to the number of channels when phase shift of PWM control is performed. That is to say, since the number of channels is 8, the number of bits of upper bits in the example in FIG. 5 is set to 3 (cnt_base[7:5]).

Thus, as shown in FIG. 6, within each period in which the PWM period Tpwm is divided by the number of channels, a period T1 (with compensation) in which (X+1) is selected and a period T2 (without compensation) in which X is selected occur. Accordingly, the period T1 with compensation is distributed in the PWM period Tpwm, for example, for an equivalent period in PWM control of each channel indicated by circles, such that compensation is similarly implemented.

Moreover, the step value is not necessarily output in an incremental order of the value for the lower bit data after swapping. Taking FIG. 5 for example, the lower 3 bit data are not necessarily in an order of 000, 001, . . . , . . . .

### 3. OTHER

Further, in addition to the embodiments, various modifications may be made to the technical features disclosed by the present disclosure without departing from the scope of the technical inventive subject thereof. That is to say, it should be understood that all aspects of the embodiments are exemplary rather than limiting, and it should also be understood that the technical scope of the present disclosure is not limited to the embodiments, but includes all modifications of equivalent meanings belonging to the claims within the scope.

### 4. NOTES

As described above, a semiconductor device (1) according to an aspect of the present disclosure is configured to include a PWM synchronization unit (4) and a PWM control unit (5), wherein the PWM synchronization unit (4) includes:

a periodic counter (41), configured to count PWM periods between externally controlled synchronization timings; and a one-step counter (43), configured that a count value of each step is set as X with a remainder as MOD when the count value of the periodic counter is divided by a predetermined resolution Y, wherein for a step number of MOD steps, (X+1) is counted per step, and for a step number of (Y−MOD) steps, X is counted per step, and the PWM control unit (5) is configured to perform PWM control based on counts of the one-step counter (first configuration).

Moreover, in the first configuration, the PWM synchronization unit is configured to include:
a comparison unit (44), configured to compare a step value output by the one-step counter and (MOD−1); and
a selection unit (42), configured to select (X+1) or X as the count value per step according to a comparison result of the comparison unit (second configuration).

Moreover, the second configuration can also be configured that, the one-step counter is configured to increase or decrease a value from 0 to (Y−1) by 1 and sequentially output the value as the step value (third configuration).

Moreover, the second configuration can also be configured that, the one-step counter is configured to, when a bit data of the step value is arranged to increase from 0 to (Y−1) by 1, output the bit data in which an upper bit and a lower bit of the bit data are swapped, as a step value for each of same lower bit data after swapping (fourth configuration).

Moreover, in the fourth configuration, a number of upper bits is a number of channels of a PWM control target, and the PWM control unit is configured to shift a phase for each channel by a period obtained by dividing the PWM period by the number of channels (fifth configuration).

Moreover, in the fifth configuration, the PWM control target is a light emitting element, and the PWM control unit is configured to perform PWM modulation of the light emitting element (sixth configuration).

Moreover, in any one of the first to sixth configurations, the synchronization timings are transmitted from an outside via UART communication (seventh configuration).

Moreover, a synchronization system according to an aspect of the present disclosure is configured to include the semiconductor device (1) of any one of the first to seventh configurations, and a control device (6) disposed outside the semiconductor device, wherein the synchronization timings are transmitted from the control device (eighth configuration).

### INDUSTRIAL APPLICABILITY

The present disclosure is applicable to semiconductor devices for various types of use.

1. A semiconductor device, comprising a PWM synchronization unit and a PWM control unit, the PWM synchronization unit includes:
a periodic counter, configured to count PWM periods between externally controlled synchronization timings; and
a one-step counter, configured that a count value of each step is set as X with a remainder as MOD when the count value of the periodic counter is divided by a predetermined resolution Y, wherein
for a step number of MOD steps, (X+1) is counted per step, and
for a step number of (Y−MOD) steps, X is counted per step, and
the PWM control unit is configured to perform PWM control based on counts of the one-step counter.

2. The semiconductor device of claim 1, wherein the PWM synchronization unit includes:
a comparison unit, configured to compare a step value output by the one-step counter and (MOD−1); and
a selection unit, configured to select (X+1) or X as the count value per step according to a comparison result of the comparison unit.

3. The semiconductor device of claim 2, wherein the one-step counter is configured to increase or decrease a value from 0 to (Y−1) by 1 and sequentially output the value as the step value.

4. The semiconductor device of claim 2, wherein the one-step counter is configured to, when a bit data of the step value is arranged to increase from 0 to (Y−1) by 1, output the bit data in which an upper bit and a lower bit of the bit data are swapped, as a step value for each of same lower bit data after swapping.

5. The semiconductor device of claim 4, wherein
a number of upper bits is a number of channels of a PWM control target, and
the PWM control unit is configured to shift a phase for each channel by a period obtained by dividing the PWM period by the number of channels.

6. The semiconductor device of claim 5, wherein
the PWM control target is a light emitting element, and
the PWM control unit is configured to perform PWM modulation of the light emitting element.

7. The semiconductor device of claim 1, wherein the synchronization timings are transmitted from an outside via UART communication.

8. A synchronization system, comprising:
the semiconductor device of claim 1;
a control device, disposed outside the semiconductor device, wherein the synchronization timings are transmitted from the control device.

9. A synchronization system, comprising:
the semiconductor device of claim 2;
a control device, disposed outside the semiconductor device, wherein the synchronization timings are transmitted from the control device.
